(19) United States
(12) Patent Application Publication
(10) Pub. No.: US 2014/0011912 A1
(43) Pub. Date: Jan. 9, 2014

(54) COATED PRESSURE SENSITIVE ADHESIVE GRANULES

(71) Applicant: HENKEL AG & CO. KGAA, Duesseldorf (DE)

(72) Inventors: Gerald Petry, Hueckelhoven (DE); Eckhard Puerkner, Duesseldorf (DE); Stephen F. Hatfield, Hickory, NC (US)

(73) Assignee: HENKEL AG & CO. KGAA, Duesseldorf (DE)

(21) Appl. No.: 14/028,580

(22) Filed: Sep. 17, 2013

Related U.S. Application Data
(63) Continuation of application No. PCT/EP2012/053789, filed on Mar. 6, 2012.
(60) Provisional application No. 61/453,718, filed on Mar. 17, 2011.

(51) Int. Cl. C09J 11/06

(52) U.S. Cl. CPC C09J 11/06
USPC 523/201; 264/141

(57) ABSTRACT

The hot melt pressure-sensitive adhesive (PSA) in the form of a granulate, the granulate comprises a core made of a hot melt pressure-sensitive adhesive and an outer layer, surrounding said core, made of a composition that is not pressure-sensitively adhesive, where the outer layer contains: 5 to 35 wt % of a hydrogenated styrene block copolymer; 20 to 65 wt % of at least one oil; and 0 to 15 wt % additives.

### FIELD OF THE INVENTION

The invention relates to granulated block-resistant hot melt adhesives, where the granulate particles are individually surrounded by a casing. This casing is intended to be compatible with the hot melt adhesive and to yield a homogeneous adhesive when melted together.

### BACKGROUND OF THE INVENTION

EP 1812297 describes a method for packaging hot melt adhesives, the adhesive being packaged by means of a casing that contains at least 25 wt % of a wax. Specific polyethylenes, as well as elastic block copolymers, are described as further constituents.

EP 0469564 describes methods for packaging hot melt adhesives. Here the casing material is said to be compatible with the adhesive. The adhesive units are described in quantities from 100 g to 4 kg. The proportion of casing material in the adhesive is therefore small. Polyolefins are furthermore described as a preferred casing material.

EP 1196509 describes granulated hot melt adhesives. Here the granulates are provided, after cooling, with special coatings. The latter are applied in liquid form onto the individual particles and form a coating on the granulate particles. Constituents that are not adhesive are described for the coating.

Disadvantages of the known casing materials are based on processing and composition. When large blocks of the adhesive are manufactured, they usually can be metered only manually. They therefore cannot be processed automatically. If smaller particles are generated, the proportion of casing material with respect to the core is considerable. Therefore not only must the casing material be soluble in the adhesive, it also must not degrade the properties as a pressure sensitive adhesive (hereinafter “PSA”). This is difficult in particular when constituents that are inherently not tacky, such as waxes, are used in casing materials. If the coating is selected to be thinner, transport is problematic because these layers then subsequently lose block resistance when damaged or in storage. It is known in this context that tacky substances diffuse out of the core into the casing and thus decrease the block resistance.

### SUMMARY OF THE INVENTION

The object of the present invention is therefore to make available a hot melt adhesive as a granulate, such that the latter can be transported in automatic conveying systems. For this purpose it exhibits block resistance when stored, and the casing material is selected so that the adhesive properties are not impaired upon homogeneous melting of the granulates. Easy miscibility of the casing material with the adhesives is also intended to exist.

The object is achieved by a hot melt adhesive in the form of a granulate, the granulate particles comprises a core made of a hot melt pressure-sensitive adhesive and having an outer layer, surrounding said core, made of a composition that is not pressure-sensitively adhesive, wherein the outer layer contains 5 to 30 wt % of a hydrogenated styrene block copolymer, 20 to 65 wt % of at least one oil, and 0 to 15 wt % additives.

The hot melt adhesive according to the present invention must be present as a granulate. A “granulate” is understood as particles that have a small size and can still flow. Such granulates made of solid materials are known in principle. They can have a size from 1 to 20 mm; preferably the particles are from 2 to 10 mm. The weight of granulate particles according to the present invention is, for example, less than 20 g, in particular less than 10 g. The shape can vary within broad limits, and is influenced by the manufacturing process. The grain preferably has a cushion-like or cylindrical or sphere-like shape; this shape can also deviate from ideal shapes and can be deformed. It is necessary according to the present invention that the particles have a non-tacky surface in order to ensure that the granulates have the property of flowing.

### DETAILED DESCRIPTION OF THE INVENTION

“Flowable” means for the invention that the granulate can still “flow” under its own weight, at temperatures from −10 to +40° C. under the inherent pressure of a 50 cm fill height, through an opening 5 cm in diameter. If the granulates do not adhere to one another in this context, the surface is block-resistant.

The material of the granulate core corresponds, in terms of the nature and quantity of the individual components, to a usual hot melt adhesive composition, in particular to a hot melt pressure-sensitive adhesive (PSA). The hot melt adhesives encompass a plurality of base polymers that are mixed with other constituents such as plasticizers, resins (tackifiers), and additives in order to constitute the adhesive. The base polymers substantially determine the adhesive layer properties in terms of adhesion, strength, and temperature characteristics. Mixtures can also be used, provided they are mutually compatible.

Suitable base polymers are, for example, elastic block copolymers such as styrene-butadiene, styrene-butadiene-styrene, styrene-isoprene-styrene, styrene-ethylene-butylene-styrene, styrene-ethylene-propylene-styrene; olefin copolymers such as ethylene-vinyl acetate polymers, ethylene-methacrylate, ethylene-n-butyl acrylate, or ethylene-acrylic acid polymers; polyolefins such as polyethylene, polypropylene, and copolymers; polyacrylates; polyamides; polyesters; polyvinyl alcohols and copolymers; polyurethane.

Particularly suitable, for example, are ethylene-vinyl acetate copolymers (EVA), (partly) crystalline polypropylene (co)polymers, amorphous polyolefins (APAO), polyethylene and copolymers, polyolefins as statistical or block copolymers or star polymers, styrene block copolymers, such as styrene-butadiene-styrene (SBS), styrene-isoprene-styrene (SIS), polybutenes, poly(meth)acrylates, for example containing C4 to C16 alkyl(meth)acrylic esters. Polymers manufactured by condensation are also suitable, for example thermoplastic non-reactive polyurethanes made in particular of diisocyanates and polyols. An embodiment of the invention utilizes inert base polymers; another embodiment utilizes polymers that contain crosslinkable functional groups that can be subjected to a crosslinking reaction after application.

The aforementioned base polymers, and additives that can influence specific properties of the adhesive such as, for example, cohesive strength, adhesion, softening point, or processing viscosity, are contained as further constituents in the suitable hot melt adhesive of the core. These additives are to be understood, for example, as plasticizers, stabilizers, waxes, adhesion promoters, antioxidants, light protection agents, pigments, fillers, or similar added substances. The quantity can be up to 70 wt %. Multiple additives can also be used as a mixture.

As a further constituent, the hot melt adhesive suitable according to the present invention contains at least one tackifying resin. The resin makes the adhesive additionally tacky. It is used in a quantity from 5 to 50 wt %, preferably 10 to 40 wt %. Resins can be selected in this context from aromatic, aliphatic, or cycloaliphatic hydrocarbon resins, as well as modified or hydrogenated derivatives. Further resins usable in the context of the invention are polyterpene resins, phenolically or aromatically modified polyterpene resins, modified natural resins, such as resin acids from balsam resin, tall resin, or wood rosin, optionally also hydroabietyl alcohol and esters thereof, acrylic acid copolymerizates such as styrene-acrylic acid copolymers, and resins based on functional hydrocarbon resins. These resins are intended according to the present invention to have a softening point of between 50 and 130° C. (ring and ball method).

Plasticizers are used by preference to adjust viscosity or flexibility, and are contained generally at a concentration from 0 to 30 wt %, by preference from 2 to 20 wt %. Suitable plasticizers are, for example, medicinal white oils, naphthenic mineral oils, polypropylene, polybutene, polyisoprene oligomers, hydrogenated polyisoprene and/or polybutadiene oligomers, paraffinic hydrocarbon oils, benzoate esters, phthalate esters, adipate esters, glycerol esters, vegetable or animal oils and derivatives thereof, polypropylene glycol, polybutylene glycol, polymethylene glycol. The plasticizers also increase the tackiness of the adhesive composition.

The hot melt adhesive can optionally have waxes added to it in quantities from 0 to 20 wt %. The quantity is adjusted so that on the one hand the viscosity is lowered into the desired range, but on the other hand adhesion is not negatively influenced. The wax can be of natural or synthetic origin. Vegetable waxes, animal waxes, mineral waxes or petrochemical waxes can be used as natural waxes. Hard waxes such as montan ester waxes, Sasol waxes, etc. can be used as chemically modified waxes. As synthetic waxes, polyalkylene waxes as well as polyethylene glycol waxes are utilized. Petrochemical waxes such as petrolatum, micro waxes, and synthetic waxes, in particular polyethylene waxes, polypropylene waxes, Fischer-Tropsch waxes, paraffin waxes, or microcrystalline waxes are used by preference.

Stabilizers are a further group of additives. Their purpose is to protect the polymers from decomposition during processing. Antioxidants are to be recited here in particular. They are added to the hot melt pressure-sensitive adhesive usually in quantities of up to 3 wt %, by preference in quantities from approximately 0.1 to 1.0 wt %.

Additives and hot melt adhesives of these kinds are known in principle to one skilled in the art, who can make a selection based on the desired properties of the hot melt adhesive.

Hot melt adhesives that are highly pressure-sensitively adhesive, for example a pressure-sensitive adhesive (PSA), are selected in particular as a hot melt adhesive of the core material. These PSAs are to understood as those adhesives which, applied as a layer onto the surface, adhere to a variety of substrates by means of light pressure. Other hot melt adhesives can, however, also be correspondingly encased. An embodiment of the invention utilizes inert hot melt pressure-sensitive adhesives as a core. Another embodiment utilizes reactive hot melt pressure-sensitive adhesives, which can be further crosslinked after application. Examples thereof are hot melt adhesives that still comprise radiation-crosslinkable groups, that can additionally be crosslinked by radical polymerization, or that can be crosslinked by condensation reactions.

Particularly suitable hot melt adhesives are those that have a low softening point, for example from 60 to 130° C., in particular from 70 to 120° C. (softening temperature measured by ring and ball, ISO 4625-1).

The layer surrounding the core made, for example, of hot melt pressure-sensitive adhesive must, in contrast thereto, exhibit non-tacky properties. The composition of the surrounding outer encasing layer is intended to be compatible with the hot melt adhesive of the core. This is to be understood to mean that upon melting of the two components, a homogeneous molten composition is obtained. The latter is intended to give rise to no phase separation in the molten state in the context of manufacturing and processing. This can be achieved by using constituents that are in principle usual and known, and that are compatible with the hot melt adhesive of the core.

The encasing layer is intended according to the present invention to contain styrene block copolymers. These are copolymers based on olefins and styrene. They are di- or multi-block polymers that also exhibit elastic properties. Hydrogenated block copolymers can also be used. The latter are known to one skilled in the art and are obtainable commercially. They can be, for example, SIS, SBS, SIBS, SIPS, SEBS, SEPS. The quantity is to be from 5 to 35 wt % based on the composition of the casing, in particular 10 to 25 wt %.

An encasing layer according to the present invention must furthermore contain 20 to 65 wt % of at least one oil. The plasticizing oils listed above can be used in principle as oils. Hydrogenated plasticizers are particularly suitable, such as mineral oils, hydrocarbons, or polyolefin oligomers. The oils are preferably selected from hydrocarbon oils, paraffinic oils, naphthenic oils, or medicinal white oils. These are highly compatible with the styrene block copolymers. “Sweating,” i.e. concentration at the surface of a corresponding layer, is not observed.

The quantity of oils in the encasing layer is intended in particular to be from 30 to 50 wt %. The quantity of oils in the encasing layer is preferably no greater than the quantity of plasticizers or oils in the composition of the hot melt pressure-sensitive adhesive.

The outer layer can furthermore also contain 0 to 15 wt % additives, in particular up to 5 wt %. “Additives” are to be understood as, for example, stabilizers, light protection agents, oxidizing agents, and similar substances.

In a particular embodiment of the invention, 5 to 30 wt % of a polyolefin copolymer can also be contained in the encasing layer. This refers to those polymers which have a softening point from 90 to 130° C. Such polyolefins are known; they are selected in particular on the basis of polyethylenes or polypropylenes or copolymers, particularly preferably as LDPE or EVA. The copolymers differ from waxes in that they usually have a higher molecular weight, for example from 15,000 to 150,000 g/mol. A composition according to the present invention of the encasing layer can furthermore also contain 0 to 25 wt % waxes. The waxes listed above as a constituent of the adhesive can be used as a wax. The quantity is intended in particular to be between 5 and 20 wt %. The quantity of waxes is to be selected so that the pressure-sensitively adhesive nature of the overall molten mixture of the casing and core is substantially not impaired. The individual constituents of the composition of the casing can be individually selected in the aforesaid quantities, provided the mixture exhibits the necessary properties. The sum of the constituents of the casing is intended to yield 100%.

In a particular embodiment, the outer layer is made up of a mixture of: −5 to 30 wt % of a styrene block copolymer, −5 to 30 wt % of a polyolefin copolymer, −0 to 20 wt % wax, −0 to 15 wt % additives, and 20 to 65 wt % of at least one oil selected from paraffinic or naphthenic oils or medicinal white oils.

The encasing layer has a softening point of less than 135° C., preferably less than 125° C., and in particular less than 115° C. It is, however, as a rule above 80° C., preferably above 90° C., in particular above 100° C. The encasing layer is block-resistant, i.e. as a granulate it does not adhere under its own weight at temperatures of up to 40° C. Block resistance exists during storage as well. In particular, a granulate according to the present invention is intended to be still flowable after storage for 2, in particular 4 months.

The weight proportion of the outer encasing layer in terms of the total weight of the adhesive is between 5 and 20 wt %, in particular between 7 and 12 wt %. The outer layer of the granulate particles is intended to have a thickness from 10 to 300 μm, in particular from 30 to 150 μm. The casing is thus stable enough to exhibit a stable surface in the context of usual operations on the granulates, such as transport, storage, and decanting, and not to adhere to one another.

A further subject of the invention is a method for manufacturing granulates from completely encased hot melt pressure-sensitive adhesive particles. The methods for manufacturing hot melt adhesive compositions and compositions of the casing of the granulate particles are known. The constituents are usually melted and are mixed in the melt. This can occur discontinuously in vessels, but it is also possible for manufacturing to be performed continuously in an extruder. The mixtures of the core material and of the casing material are individually solid at room temperature. They are usually free of organic solvents.

In a preferred manufacturing form, the molten components (core, casing) of the granulate particles are processed by coextrusion. Here the hot melt adhesive is discharged in strand form through a central nozzle, and concurrently therewith the casing material is extruded through a further annular nozzle and placed around the strand. It is known to perform the extrusion operation under water, or to cool the extruded strand immediately thereafter in water or in other liquids.

In order to manufacture the granulates it is then necessary to divide the strand into individual particles. This can be carried out in principle using known actions such as cutting or pinching, the strand made up of the core and casing being detached together. Separation occurs at a point in time at which the material is still plastic, i.e. a deformation of the core and casing can still take place. It is thereby possible to ensure that the flexibility at this point in time is sufficient to carry the encasing layer entirely around the cut-through end of the core material. The cut edges become sealed, for example adhesively bonded, fused, or welded, without a further processing step. This ensures that the individual granulate particles are completely covered by a layer of the outer casing material. The individual granulate particles therefore exhibit only two thin seams in the casing.

The resulting adhesive granulates according to the present invention are small. The size can be, for example, 10×10×15 mm; the weight of a particle is less than 20 g, preferably 0.1 to 10 g, in particular 0.3 to 5 g.

The granulates according to the present invention are cooled after they are manufactured. They are thus dimensionally stable and no longer adhere to one another. These granulates can then be decanted into known packaging means, for example barrels, canisters, cartons, bags, or containers. The granulates according to the present invention can be stored in these packing units. It has been found that they do not block at a temperature of up to 40° C., i.e. even after extended storage or transport at a corresponding temperature, the granulates are free-flowing and can be taken out of the containers. The hot melt adhesive granulates according to the present invention are then intended to be melted prior to application. For this, they are removed from the containers and conveyed, for example via a mechanical transport apparatus, to a melting tank. There these granulates are melted and delivered to the application stations, optionally accompanied by mixing.

Because the granulates weigh very little, it is possible to melt and apply only small quantities of the hot melt adhesive. Thermal stress on the hot melt adhesive granulates according to the present invention is decreased in this context. It is additionally possible to transport these granulates using automatic conveying devices, for example compressed-air or vacuum conveying devices. Increased automation of the adhesive application process is thereby possible. In addition, customers can be supplied with larger quantities of the adhesive, but application in small quantities, corresponding only to the actual need, is possible. This improves stock management and logistics for the adhesives.

Further advantages of the hot melt adhesives according to the present invention are apparent as improved shelf stability. Migration into the outer encasing layer of substances that increase surface tackiness is avoided, and the blocking resistance of the granulates is thereby improved.

The Examples are intended to explain the invention.

### Manufacturing Method for Hot Melt Pressure-Sensitive Adhesive:

The polymers were melted and mixed at 180° C. in a laboratory stirrer. The further formula constituents were then added and completely homogenized, and optionally degassed. The molten mixture was decanted and the cooled, whereupon it solidified.

TABLE 1
Composition of hot melt adhesives

| Constituents | | Hot melt adhesive | | |
|---|---|---|---|---|
| | Trade name | Ex. 1 | Ex. 2 | Ex. 3 |
| APAO | Vestoplast 704 | — | 35.0% | — |
| APAO | Vestoplast 750 | — | 5.0% | 31% |
| EVA | Escorene UL 15019 | — | — | 4% |
| EVA | Evatane 28-05 | 10% | — | — |
| SBS | Europrene Sol 1205 | 17% | — | — |
| Plasticizer | DINP | 9% | — | — |
| Oil | Primol 352 | 8% | 19.0% | 30% |
| Resin | MBG-278 | — | 20.0% | — |
| Resin | Escorez 5320 | — | — | 35% |
| Resin | Regalite ® R 91 | — | 20.0% | — |
| Resin | Sylvalite RE 105S | 55% | — | — |
| Antioxidants | Irganox 1010 | 1% | 1.0% | — |

The constituents listed are commercially usual products.

TABLE 2
Properties of hot melt adhesives

| Property | Example 1 | Example 2 | Example 3 |
|---|---|---|---|
| Melt viscosity (mPas) at 150° C. | | 1150 | 3500 |
| Softening point (° C.) | 80 to 90 | 76 | 75 |

### Hot Melt Adhesive 4:

Radiation-curing hot melt adhesive made up of:

80 g of a copolymer based on acrylate esters with reacted-on initiators (AC Resin A 204 UV) was melted with 20 g of a resin (Kristalex) at approx. 130° C. to 150° C. while stirring, homogenized, then cooled, whereupon the adhesive became solid.

### Casing Composition 1:

15 g of an SEBS copolymer (Kraton G 1652), 5 g of a resin (Escorez 5320), 15 g of a wax (Sasolwax H1), 20 g of a polyethylene (Escorene LD 655), 0.05 g of a stabilizer (Irganox 1010), and 44.5 g of an oil (Primol 352) were melted at approx. 190° C. while stirring, and homogenized.

Softening point: 112° C.

### Casing Composition 2:

20 g of an SEBS copolymer (Kraton G 1652), 10 g of a resin (Escorez 5400), 15 g of a wax (Sasolwax H1), 15 g of a polyethylene (Escorene LD 655), 0.05 g of a stabilizer (Irganox 1010), and 39.5 g of an oil (Primol 352) were melted at approx. 190° C. while stirring, and homogenized.

Softening point: 102° C.

### Manufacturing the Granulates:

A hot melt adhesive according to Examples 1 to 4 is melted. Concurrently therewith, a casing mixture 1 or 2 is melted.

In an extruder, the adhesive is discharged through a central nozzle, and the casing material through an annular nozzle, underwater. An encased tube (diameter approx. 5 mm) was produced, which was immediately cooled. The strand was transported further and then separated into short pillow-shaped pieces by being pinched off. These were cooled to room temperature in a cooling bath. They were then no longer tacky, are shelf-stable, and were capable of being dried.

The size of the individual particles was approx. 8×8×5 mm, and the weight approx. 1.5 g.

The casing quantity was determined by the melts being discharged; it was approx. 12 wt %.

Core 1+casing 1 Core 2+casing 1

Core 3+casing 2 Core 4+casing 2

The granulates were all free-flowing. The mixture remained free-flowing even after storage for 1 month at 95% relative humidity, 50 cm bulk height, at 35° C.

A flowable pressure-sensitive adhesive was manufactured from the granulates (1 to 3) by melting. This adhesive was applied using the usual pumps and dispensing devices, and yielded a pressure-sensitive adhesive layer after cooling.

We claim:

1. A hot melt pressure-sensitive adhesive in the form of a granulate, the granulate comprises:
(1) a core made of the hot melt pressure-sensitive adhesive and
(2) an outer layer, surrounding said core, made from a composition comprising
(a) 5 to 35 wt % of a styrene block copolymer, (b) 20 to 65 wt % of at least one oil, and (c) 0 to 15 wt % additives, and
wherein the outer layer is not a pressure-sensitive adhesive.

2. The hot melt pressure-sensitive adhesive according to claim 1, wherein the composition further comprises 5 to 30 wt % of a polyolefin copolymer selected from LDPE or EVA.

3. The hot melt pressure-sensitive adhesive according to claim 1, wherein the oil is selected from hydrocarbon oil, paraffin oils, naphthenic oil or medicinal white oils.

4. The hot melt pressure-sensitive adhesive according to claim 3, wherein the quantity of oil in the outer layer is greater than the combined quantities of oil and plasticizer in the core.

5. The hot melt pressure-sensitive adhesive according to claim 1, wherein the weight of the outer layer is 5 to 20 wt % of the total weight of the granulate.

6. The hot melt pressure-sensitive adhesive according to claim 1, wherein the outer layer has a softening point range of 80 to 135° C.

7. The hot melt pressure-sensitive adhesive according to claim 1, wherein the granulate is free-flowing.

8. The hot melt pressure-sensitive adhesive according to claim 1, wherein the outer layer comprises a casing made from the composition comprising:
(a) 5 to 30 wt % of a styrene block copolymer;
(b) 5 to 30 wt % of a polyolefin copolymer;
(c) 20 to 65 wt % of at least one oil;
(d) 0 to 20 wt % wax; and
(e) 0 to 15 wt % additives.

9. The hot melt pressure-sensitive adhesive according to claim 1, wherein each granulate has a weight of less than 20 g.

10. The hot melt pressure-sensitive adhesive according to claim 8, wherein the casing of the outer layer comprises two substantially closed seams.

11. A method for manufacturing a granulate, which is a hot melt pressure-sensitive adhesive core surrounded by a non-pressure sensitive adhesive casing, comprising the steps of:
(1) extruding the core;
(2) extruding the casing around the core to from an encased layer; and
(3) separating the encased layer to forming two seams;
wherein the casing comprises (a) 5 to 35 wt % of a styrene block copolymer, (b) 20 to 65 wt % of at least one oil, and (c) 0 to 15 wt % additives; and
wherein the steps (1) and (2) are simultaneously coextruded.

12. The method according to claim 11, further comprising step (4) closing the seams by melting, sealing or welding.

13. The method according to claim 11, wherein the separating pinching or cutting.

14. An article comprising the granulate of claim 1.
